(19) United States
(12) Patent Application Publication
(10) Pub. No.: US 2026/0259096 A1
(43) Pub. Date: Sep. 3, 2026

(54) TIRE PRESSURE DETECTION SYSTEM FOR STATIONARY VEHICLE

(71) Applicant: SENSATA TECHNOLOGIES, INC., Attleboro, MA (US)

(72) Inventors: GARY SMITH, Swindon (GB); EUGENE BRENNAN, Kilrea (GB)

(73) Assignee: SENSATA TECHNOLOGIES, INC., Attleboro, MA (US)

(21) Appl. No.: 18/667,930

(22) PCT Filed: Nov. 18, 2022
(86) PCT No.: PCT/US2022/050432

§ 371 Date: May 17, 2024

Related U.S. Application Data
(60) Provisional application No. 63/281,416, filed on Nov. 19, 2021.

(51) Int. Cl. G01L 17/00; B60C 23/04

(52) U.S. Cl. CPC G01L 17/00; B60C 23/0408

(57) ABSTRACT

A system and method determine tire pressure anomalies when a vehicle is stationary. A motion sensor determines that a vehicle is stationary. A sampling rate of a pressure sensor is adjusted to a non-zero sampling rate with the vehicle stationary, and sampled pressure measurements are compared to acceptable tire pressures to determine anomalies. The location of the tire anomaly may also be determined using reference and updated motion data. A driver or other individual associated with the vehicle is alerted to details about the anomaly before extensive vehicle operation.

### CROSS-REFERENCE TO RELATED APPLICATIONS

This application is a National Phase application, filed under 35 U.S.C. § 371, of International Application No. PCT/US 2022/050432, filed Nov. 18, 2022, titled “TIRE PRESSURE MONITORING IN STATIONARY VEHICLE,” which International Application claims priority to U.S. Provisional Application No. 63/281,416, filed Nov. 19, 2021, and titled “TIRE PRESSURE DETECTION SYSTEM FOR STATIONARY VEHICLE,” and the entirety of each of which are hereby incorporated by reference.

### FIELD OF THE TECHNOLOGY

The subject disclosure relates to tire pressure monitoring systems, and more particularly to tire pressure monitoring systems for identifying and alerting to anomalous tire pressures while a vehicle is stationary.

### BACKGROUND OF TECHNOLOGY

A conventional tire pressure monitoring (TPM) system for use in a vehicle receives data from tire pressure detectors or monitors to determine safety data associated with the vehicle. For instance, tires having low tire pressure may be unsafe and/or may reduce operating efficiency of the vehicle, e.g., by reducing gas mileage. Some conventional TPM systems include processing to determine tire pressure during operation of a vehicle. For example, such systems may sample tire pressure readings at some sampling rate to determine whether tire pressures comport with operational thresholds, commencing with starting of the vehicle. To conserve energy, reduce processing requirements, and/or for other reasons, the tire pressure sampling rate in conventional systems may be relatively long, which can result in initial tire pressure readings (e.g., upon vehicle start up) to be delayed to the driver. In some circumstances, the driver is not alerted to an anomalous tire pressure until after travel has commenced, which can lead to unsafe operation of the vehicle, annoyance to the driver, and other unwanted consequences.

### SUMMARY OF THE TECHNOLOGY

In light of the needs described above, in at least one aspect, the subject technology relates to improved TPM systems and methods of using such systems. For example, aspects of this disclosure can be used to alert users to pressure anomalies, e.g., which may correspond to unsafe operating conditions of the vehicle, while the vehicle is stationary or promptly after start-up of the vehicle. Moreover, some of the techniques and systems described herein may facilitate accurate identification of a location of a tire on a vehicle, e.g., which the vehicle is stationary, such that a position of a tire with a pressure anomaly may be communicated to a driver, vehicle owner, or the like.

### BRIEF DESCRIPTION OF THE DRAWINGS

So that those having ordinary skill in the art to which the disclosed systems and techniques pertain will more readily understand how to make and use the same, reference may be had to the following drawings.

FIG. 1 is a schematic representation of a vehicle including tire pressure monitors and a tire pressure monitoring control module, in accordance with aspects of this disclosure.

FIG. 2 is a flowchart illustrating an example process for monitoring tire pressure, in accordance with aspects of this disclosure.

FIG. 3 is a flowchart illustrating an example process for monitoring tire pressure in stationary vehicles, in accordance with aspects of this disclosure.

### DETAILED DESCRIPTION

The subject technology overcomes many of the prior art problems associated with tire pressure sensing in vehicles. In brief summary, the subject technology provides tire monitoring systems that allow for identification and/or determination of pressure anomalies while a vehicle is stationary, or promptly upon vehicle motion.

In some aspects of this disclosure, a vehicle has an associated tire pressure monitoring system that is configured to determine information about tire status. For instance, the tire pressure monitoring (TPM) system may include one or more computing systems on or associated with the vehicle that is/are configured to receive, generate, and/or otherwise process data relating to tire pressures. For instance, a vehicle may include four tires, and a tire monitor may be associated with each of the four tires. The computing system(s) of the TPM system can receive data from the monitors and/or transmit data to the monitors.

In examples, the tire monitors include a pressure sensor configured to generate data associated with a pressure of the associated tire. The tire monitors may also include one or more motion sensors, e.g., to generate sensor data associated with movement of the associated tire. In examples, the motion sensor can include one or more of an accelerometer, a gyroscope and/or other sensor modalities configured for motion detection. In examples, the pressure sensor and/or the motion sensor may be configurable. For instance, a sampling rate of the pressure sensor and/or a sampling rate of the motion sensor(s) may be configurable.

In example implementations, the systems and techniques described herein may use data from the pressure sensor(s) and/or the motion sensor(s) to determine whether a tire has an anomalous pressure condition (e.g., underinflated, overinflated, or the like). As noted above, such conditions may cause unsafe and/or inefficient driving conditions. For example, the systems and techniques described herein may determine, e.g., based on the motion sensor data, that a vehicle has become stationary. For example, the vehicle being stationary may correspond to the vehicle being parked, vacated, and/or the like.

Also in examples of this disclosure, the systems and techniques described herein can, upon determining that the vehicle is stationary, configure the tire monitors to sample tire pressures at a non-zero sampling rate. In conventional systems, tire pressure monitoring is not done while a vehicle is stationary, e.g., to conserve battery and/or for other purposes. In examples of this disclosure, the non-zero sampling rate can be once every five minutes, once every fifteen minutes, once an hour, or some other rate. By sampling the tire pressure at some rate while the vehicle is stationary, tire pressure anomalies can more readily be detected even when the vehicle is not in use. More specifically, the techniques described herein can include comparing the sample tire pressures to one or more threshold pressures to determine tire pressure anomalies. For example, the tire pressure measurements taken while the vehicle is stationary may be compared to a first (relatively lower pressure) to determine whether a tire is underinflated and/or to a second (relatively higher pressure) to determine whether a tire is overinflated.

In some examples of this disclosure, whether a tire has an anomalous tire pressure may be determined at the tire monitor. In such instances, information about the anomalous tire pressure may be transmitted from the monitor, e.g., to the computing system(s) associated with the TPM system. For example, the information about the anomalous tire pressure may include one or more of an indication of the anomalous tire pressure, a value associated with the anomalous tire pressure, information about a location of the tire with the anomalous tire pressure (e.g., a location on the vehicle), or the like.

Also in examples, the information about the anomalous tire pressure from the tire monitor may include a wake-up signal that configures the computing system(s) associated with the TPM system(s) to wake-up. For instance, upon receiving the wake-up signal, the computing system(s) may become functional to perform additional actions, e.g., with the vehicle still unoccupied, not in use, or the like. Without limitation, the wake-up signal may cause the computing system(s) to cause an alert or other data about the anomalous tire pressure condition to be displayed on a display of the vehicle. For example, the computing system(s) can cause an alert about the anomalous tire pressure to be displayed substantially immediately upon start-up of the vehicle, e.g., as warning or the like. This is in contrast to conventional systems that only begin sensing tire pressures at start up or initialization of the vehicle, which sensing (and associated processing) may take significantly long that a driver may have begun to operate the vehicle. In additional examples, the computing system(s) can cause an alert to be transmitted to a person associated with the vehicle. More specifically, the computing system(s) can transmit an alert to a user device, such as a smart phone, or the like, that may be configured to alert the user to the tire pressure anomaly. In this way, the user of the vehicle may know of the tire pressure anomaly at the time of detection of the anomaly, e.g., even if the user is not near or otherwise using the vehicle.

In other examples, for instance because communication between the tire monitor(s) and/or the computing system(s) associated with the TPM system may be unreliable, the techniques described herein can also include causing a motion sampling rate to be increased. In some instances, the computing system(s) associated with the vehicle may be unable to receive the wake signal and/or the information associated with anomalous tire pressure. Aspects of this disclosure may include lower the wake threshold for the computing system(s) and/or increasing the motion sensor sampling rate such that movement of the vehicle is detected more quickly, e.g., as opposed to conventional sampling rates that may take several seconds or more to detect movement. In these conventional systems, in addition to taking several seconds to determine that the vehicle is moving, the tire pressure may not be sampled until after motion is detected, thereby further delaying identification of an anomalous tire pressure. In contrast, according to aspects of this disclosure, a driver of the vehicle is alerted to the anomalous tire pressure substantially immediately upon beginning to drive the vehicle, e.g., with a second or less.

Additional examples of this disclosure can include determining a position of a tire having an anomalous tire pressure. For example, the techniques and systems described herein can include determining, e.g., via auto-location techniques, semi-manual techniques, or the like, respective locations of tires on a vehicle. Upon determining that the vehicle is stationary, the systems described herein can determine, from the motion sensor(s) a reference motion reading, e.g., indicative of a current position, orientation, or the like of the tire. When a tire pressure anomaly is detected, the techniques described herein can include determining an update motion reading from the motion sensor(s). When the updated motion reading matches or substantially matches the reference motion reading, the previous location of the tire may be confirmed. Thus, a position of the tire with the anomalous tire pressure measurement may be determined. Alternatively, if the updated motion reading varies from the reference motion reading, e.g., by some threshold difference, the location of the tire may not be confirmed, although the driver or other person may still be alerted to the existence of an anomalous tire pressure measurement, using the other techniques detailed herein.

The systems and techniques described herein are an improvement over conventional systems and techniques. For example, the techniques described herein can alert a driver or other individual associated with a vehicle to tire pressure anomalies that may negatively impact driving. Accordingly, corrective action may be taken prior to driving the vehicle, thereby reducing risk of injury, damage, and/or other loss. These and other advantages and features of the systems and methods disclosed herein will become more readily apparent to those having ordinary skill in the art from the following detailed description of certain preferred embodiments taken in conjunction with the drawings which set forth representative examples of the present disclosure.

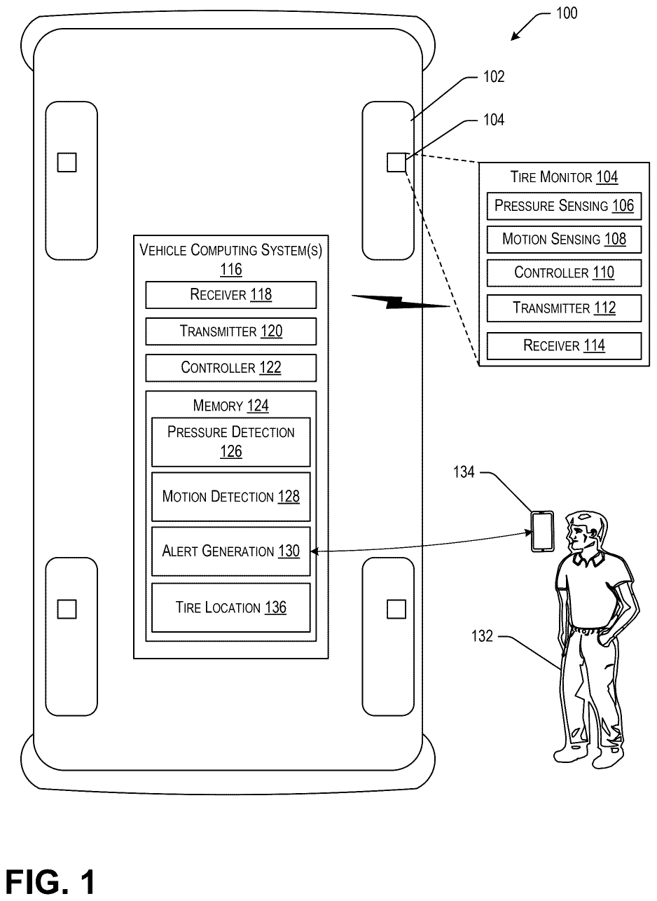

FIG. 1 illustrates a vehicle 100 including a number of tires 102. Each of the tires 102 includes a tire monitor 104. Specifically, each of the tires 102 has an associated one of the tire monitors 104. Each of the tire monitors 104 can also include, among other features, a pressure sensing component 106, a motion sensing component 108, a controller 110, a transmitter 112, and a receiver 114. Although not illustrated in FIG. 1, each of the tire monitors 104 may also include one or more power sources, e.g., batteries, and/or other conventionally-known components.

The pressure sensing component 106 is configured to generate a signal indicating a measured pressure associated with the tire 102. The pressure sensing component 106 may generate an updated pressure signal at a predetermined frequency, e.g., according to a pressure sampling rate. The pressure sensing component 106 may be configurable, e.g., the sampling rate may be adjustable. In examples described herein, the sampling rate may be adjusted such that the pressure sensing component 106 can be configured to generate pressure data at a first sampling rate when the vehicle is in motion and at a second sampling rate when the vehicle is stationary. The second sampling rate may be a non-zero sampling rate and may be on the order of about one sample per every about 10 to 20 seconds.

The pressure sensing component 104 can also include functionality to compare a measured pressure to one or more threshold pressures or the like, e.g., to determine whether a tire is properly pressurized. Without limitation, the pressure sensing component 104 can include functionality to compare a measured pressure to a first, relatively lower threshold pressure and/or to a second, relatively higher threshold pressure. In examples, if the measured pressure is equal to or below the first threshold, the tire may be underinflated. Alternatively, if the measured pressure is equal to or above the second threshold pressure, the tire may be overinflated. Other thresholding schemes to determine anomalous tire pressure values also may be used. Moreover, although the determination of whether a tire pressure is anomalous is described herein as being performed by the pressure sensing component 106, in other examples, an additional or alterative component may process pressure data to identify anomalous tire pressure measurements.

The motion sensing component 108 is configured to generate information associated with motion of the tire 102. For example, the motion sensing component 108 can include an inertial motion unit, a resolver, a rotary sensor, a position sensor, an accelerometer, a gyroscope, and/or the like. The motion sensing component 108 can generate motion data at a predetermined rate. In examples of this disclosure, data from the motion sensing component 108 can be used to determine when a tire (and therefore a vehicle) is stationary and/or when the tire/vehicle is in motion. Moreover, in some examples, the motion sensing component 108 is configurable, e.g., to generate and output motion data at different sampling rates and/or in response to certain conditions. In at least some examples described herein, the motion sensing component 108 can generate reference motion data when a vehicle stops and generate updated motion data if a pressure anomaly is detected. In some instances, the motion sensing component 108 can determine a location of the tire monitor 104, and thus the associated tire 102, on the vehicle 100.

The controller 110 may be configured to control aspects of the tire monitor 104. For instance, and without limitation, the controller 110 can control sampling rates of the pressure sensing component 106 and/or of the motion sensing component 108. Moreover, the controller 110 can include functionality to generate signals, e.g., corresponding to tire pressure anomalies, tire movement, or the like. The controller 110 can also include logic to perform functionality associated with the processes described herein, including one or more of the operations discussed below in connection with the processes 200, 300.

The transmitter 112 may be configured to send information, e.g., pressure information generated by the pressure sensing component 106, motion information generated by the motion sensing component 108, and/or information generated by the controller 110. Also in examples, the transmitter 112 can be configured to send a wake signal, e.g., to a vehicle computing system, to alert the vehicle to an unsafe tire pressure. In examples, the transmitter 112 can be adapted to transmit data according to any of a number of conventional protocols, including but not limited to wired and/or wireless protocols including but not limited to RF protocols, cellular protocols, near-field transmission protocols, and/or the like.

The receiver 114 may be configured to receive information from a remote source. For instance, the receiver 114 may be configured to receive instructions from one or more additional components on the vehicle 100 and/or remote from the vehicle 100. Without limitation, the receiver 114 may be configured to receive requests to generate and/or transmit data associated with pressure and/or motion. The receiver 114 can be adapted to receive data according to any of a number of conventional protocols, including but not limited to wired and/or wireless protocols including but not limited to RF protocols, cellular protocols, near-field transmission protocols, and/or the like.

As illustrated in FIG. 1, the vehicle 100 also includes one or more vehicle computing system(s) 116. Although shown as separate from the tire monitor 104, in some examples, components and/or functionality of the tire monitor 104 and the vehicle computing system(s) 116 may be part of a single system, e.g. a tire pressure monitoring system. Without limitation, some of the functionality ascribed above to aspects of the tire monitor 104, including the controller 110, may be performed at the vehicle computing system(s) 116. As shown in FIG. 1, the vehicle computing system(s) 116 includes a receiver 118, a transmitter 120, a controller 122, and memory 124. The memory 124 can include a pressure detection component 126, a motion detection component 128, an alert generation component 130, and/or a tire location component 136.

The receiver 118 may be configured to receive transmissions from the transmitter 112 of the tire monitor 104. For instance, the receiver 118 can receive pressure information and/or motion information from the tire monitor 104. Without limitation, the pressure information may be information about an anomalous pressure measurement, including but not limited to an indication that a measurement is anomalous, a value associated with the anomalous tire pressure measurement, or the like. In further examples, the pressure information can be raw data, such as pressure measurements, and the vehicle computing system(s) 116 may include functionality to determine whether the received data corresponds to an anomalous tire pressure.

The receiver 118 can also be configured to receive a wake signal. For instance, upon detecting an anomalous tire pressure measurement, the tire monitor 104 can send a wake signal to the receiver 118 to cause aspects of the vehicle computing system(s) 116 to become active, e.g., to generate an alert associated with the anomalous tire pressure measurement. The receiver 118 can be adapted to receive data according to any of a number of conventional protocols.

The transmitter 120 may be configured to transmit data. For instance, the transmitter 120 can transmit data to the tire monitor 104, e.g., to request information, to instruct a reconfiguration such as a modified sampling rate, or the like. The transmitter 120 can also be configured to transmit data to other electronic devices, e.g., an electronic device associated with an owner of the vehicle 100, to a display of the vehicle 100, or the like. The transmitter 120 may be configured to send data according to any of a number of conventional protocols.

The controller 122 may be configured to perform actions according to aspects of this disclosure. Without limitation, the controller 122 can be configured to generate instructions, alerts, or other commands. For example, the controller can be configured to perform acts associated with components stored in the memory 124 and/or to perform operations of the processes 200, 300 discussed below.

The pressure detection component 126 includes functionality to determine tire pressure anomalies. Although shown as part of the vehicle computing system(s) 116, functionality associated with the pressure detection component 126 can be implemented at the tire monitor 104, e.g., at the pressure sensing component 106. The pressure detection component 126 includes functionality to determine a pressure of the tire 102. In examples, the pressure detection component 126 can also compare a sampled pressure to one or more pressure thresholds. For example, the pressure detection component 126 can include functionality to determine whether a tire pressure is within a normal operating pressure range or whether the tire pressure is outside the normal operating range. In the latter case, the pressure detection component 126 can determine that a tire pressure is anomalous. The pressure detection component 126 can also generate instructions to cause the pressure sensing component 106 to alter a sampling rate, e.g., a rate at which the pressure sensing component 106 determines a pressure of the tire 102. For instance, the pressure detection component 126 can cause the pressure sensing component 106 to determine a pressure of the tire 102 at a first rate when the vehicle 100 is moving and at a second rate when the vehicle is stationary. As detailed herein, according to aspects of this disclosure, the pressure sensing component 106 may be configured to determine, e.g., to sample, the tire pressure at a non-zero rate that allows for identification of tire pressure anomalies even when the vehicle is not in use.

The motion detection component 128 can include functionality to determine whether a vehicle 100 is moving or stationary. Although shown as part of the vehicle computing system(s) 116, functionality associated with the pressure detection component 126 can be implemented at the tire monitor 104, e.g., at the motion sensing component 108. In more detail, the motion detection component 128 may receive data from one or more sensors, e.g., motion sensors, and determine from that data whether the vehicle is stationary or moving. For example, the motion detection component 128 can also determine a duration for which the vehicle is stationary, e.g., to determine whether a vehicle is merely stopped transiently, e.g., because of a stop light, traffic, or the like, or whether the vehicle is stopped because of non-use. In examples, the motion detection component 128 may receive additional information from the vehicle 100, including but not limited information associated with whether a key is presently associated with the vehicle, information associated with whether the engine is running, information associated with whether an occupant is in the vehicle, information associated with whether other systems of the vehicle are in use, and/or any other information that might be used to determine whether a vehicle is stationary and/or whether the vehicle is expected to remain stationary, e.g., because of non-use.

The techniques described herein may use data from the motion detection component 128 to determine when the vehicle 100 is stationary. While conventional systems may allow for determining tire pressure while a vehicle is moving, aspects of this disclosure allow for tire pressure of a stationary vehicle to be determined. Accordingly, aspects of this disclosure may be predicated upon a determination that the vehicle is stationary to perform additional functions. By detecting tire pressure anomalies while the vehicle 100 is stopped, the systems and techniques described herein can limit (or eliminate) the distance the vehicle 100 is driven with improperly inflated tires 102. In examples described herein, the motion detection component 128 can cause the motion sensing component to generate motion data in response to determining an anomalous tire pressure. Moreover, the motion detection component 128 can include functionality to increase a motion detection sampling rate, e.g., such that motion is detected more quickly upon moving the vehicle 100 when an anomalous tire pressure is determined.

The alert generation component 130 can include functionality to generate alerts, warnings, and/or other messages. In examples described herein, alerts can be generated and transmitted to a driver of the vehicle 100, e.g., via on-vehicle displays, haptic feedback elements, or the like. Accordingly, upon entering the vehicle 100, and in some instances prior to driving the vehicle, the driver may be alerted to an anomalous tire pressure.

In other examples, the alert generation component can generate alerts to be transmitted, e.g., via the transmitter 120, to a user associated with the vehicle. Such a user 132 is illustrated in FIG. 1. Without limitation, the user 132 may be an owner of the vehicle 100, an authorized or potential driver of the vehicle 100, a technician associated with the vehicle 100, and/or any other individual. As also shown in FIG. 1, the user 132 has an associated user device 134. The user device 134 may be configured to receive alerts from the vehicle computing system(s) 116, e.g., regardless of a proximity of the user 132 to the vehicle 100. For example, the alert generation component 130 can generate an alert to be transmitted, e.g., via the transmitter 120, to the user device 134, which be a smart phone, laptop, tablet, wearable, or any other device capable of receiving and/or presenting data to the user 134. As will be appreciated, by alerting the user 132 to the anomalous tire pressure reading, the user 132 can plan to take corrective action, e.g., before driving the vehicle 100.

The tire location component 136 includes functionality to locate tires on the vehicle. For example, the tire location component 136 can implement an auto-location sequence that automatically determines, e.g., while the vehicle 100 is in motion, a location of the tire monitors on the vehicle 100. For example, the tire location component 136 can determine an association of each of the tire monitors with one of a front or rear of the vehicle and/or one of a driver side or a passenger side of the vehicle. The tire location component 136 may be configured to store locations of the monitors, which locations are determined during driving of the vehicle. Although illustrated in FIG. 1 as being part of the vehicle computing system(s) 116, some or all of the functionality of the tire location component 136 can be implemented at the tire monitor 104. For example, and without limitation, the tire monitor 104 can include functionality to determine its location, e.g., based on (rotational) motion of the tire, forces experienced by the tire during driving, and/or other attributes of the tire.

In examples of this disclosure, tire location information can be included in an alert to a driver or the user 132. Moreover, in some aspects of this disclosure, the tire location component 136 can also include functionality to confirm a tire location. For example, and as just described, the tire location component 136 may be configured to determine locations of the tire monitors 104 while the vehicle is moving. These locations may be stored in memory, e.g., the memory 124 and/or memory associated with the tire monitor 104 (not shown), when the vehicle is stationary. The tire location component 136 can include additional functionality to receive reference motion data, e.g., from the motion sensing component 108, associated with the tires 102. Then, when an anomalous tire pressure measurement is detected, e.g., by the pressure detection component 126, the tire location component 136 can include functionality to receive updated motion data, e.g., from the motion sensing component 108, associated with the tires 102.

The tire location component 136 can include functionality to compare the reference motion data and the updated motion data to determine whether the associated tire has moved (e.g., despite the vehicle being stationary). For instance, if the tire location component 136 determines that the reference motion data corresponds to the updated motion data, the tire location component can confirm that the location previously associated with the tire 102/tire monitor 104 is still the location of the tire 102/tire monitor 104 (and thus the location of the anomalous tire pressure measurement). Alternatively, if the tire location component 136 determines that the reference motion data does not correspond to the updated motion data, the tire location component 136 can determine that the tire 102/tire monitor 104 may have moved while the vehicle is stationary, and thus the location of the tire with the anomalous tire pressure measurement may have moved. In examples, an alert generated by the alert generation component 130 can include information about the location of the tire with the anomalous tire pressure measurement, including the confirmed location of the tire or an indication that the tire may have moved (which can also include a previous location of the tire).

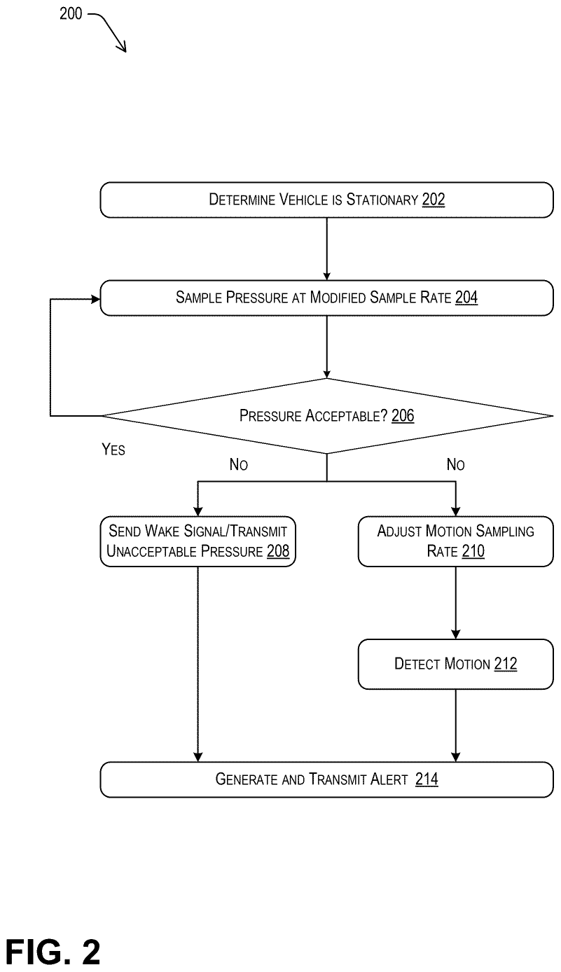

FIG. 2 is a flowchart showing an example process 200 for determining tire pressure anomalies, e.g., caused by underinflation, overinflation, and/or the like, in stationary vehicles. Specifically, at an operation 202, the process 200 includes determining that the vehicle is stationary. For instance, the operation 202 can include receiving data from one or more sensors, like the motion sensing component 108 detailed above. The sensors can include shock sensors, accelerometers, and/or any other sensor that may generate data that could be used to determine whether the vehicle 100 is stationary. In examples, such sensors may be connected via analog circuitry to a microcontroller, e.g., the controller 110 and/or the controller 122. Also in examples, the operation 202 can include receiving data from other vehicle sources, including but not limited to information about whether a driver is in the vehicle or the like.

At an operation 204, the process 200 includes sampling a tire pressure at a modified pressure sampling rate. The modified pressure sampling rate may be a predetermined, non-zero sampling rate. In examples, the frequency may be a lower frequency than a sampling rate used while the vehicle is in motion, but higher than a zero frequency. In some conventional systems, while a vehicle is stationary, the sampling rate may be reduced to zero, to once an hour, or some similarly low frequency. For instance, reducing the sampling rate in this manner will reduce battery usage while the vehicle is stationary and when tire pressure is less likely to be of interest. In contrast, when in motion, pressure may be sampled on the order of about once per second or more frequently. In aspects of this disclosure, the operation 204 may include sampling pressure at the tire at a frequency of from about five seconds to about ten seconds. For instance, the frequency at which the tire pressure is sampled may be selected empirically, e.g., based on a time it takes a driver or passenger to get into a vehicle and begin to operate the vehicle. The frequency may be selected such that an anomalous tire-pressure warning can be generated and transmitted to the driver/passenger prior to the vehicle beginning to move in an unsafe state. The frequency may also be selected to minimize an impact on battery life.

At an operation 206, the process 200 includes determining whether the sampled pressure corresponds to an acceptable pressure. In some examples, the operation 206 can include comparing the sampled pressure to a threshold pressure. The threshold pressure may correspond to, or be based at least in part on, a minimum pressure at which the tire can operate safely. In other examples, the operation 206 can include comparing the sampled pressure to more than one threshold, e.g., a minimum pressure and a maximum pressure. The operation 206 may be performed at the tire monitor 104 (e.g., by the pressure sensing component 106) and/or at the vehicle computing system(s) 116 (e.g., by the pressure detection component 126).

If, at the operation 206 it is determined that the sampled pressure is not an acceptable pressure, at an operation 208 the process 200 may include transmitting data associated with the unacceptable pressure. For example, the operation 208 can include transmitting a wake signal or transmission to wake the vehicle receiver, e.g., the receiver 118. In some examples, the operation 208 may be repeated some number of times and/or over a predetermined time period, e.g., to increase a likelihood that the signal is received. For instance, upon receiving the wake signal, the vehicle receiver can configure the vehicle computing system(s) 116 to receive the data associated with the unacceptable tire pressure. Thus, at the operation 208, the vehicle, e.g., the vehicle computing systems(s) 116, will be alerted to the unacceptable pressure while the vehicle is still stationary.

In addition, if at the operation 206 it is determined that the sampled pressure is not an acceptable pressure, at an operation 210 the process 200 may also or alternatively include adjusting a motion sampling rate. For instance, the operation 206 can include lowering a wake threshold and increasing the motion sampling rate for the motion sensing component 108 associated with the tire monitor 104. In examples, the operations 208 and 210 can both be performed, e.g., as a check to each. For instance, the operation 208 may be preferred in some instances, e.g., because it can alert a driver or other user to a potential tire issue while the vehicle is still stationary. In contrast, the operation 210 can be useful should the monitor not be able to communicate with the vehicle, e.g., due to RF null spots, the vehicle receiver being off or not able to wake during non-use of the vehicle, and/or the like. That is, the operation 210, by increasing the motion sampling rate to more quickly receive motion data, which may trigger communication of tire pressure data. Thus, the operation 210 may enable communicating the unacceptable tire pressure at the earliest possible time when the vehicle is active. For example, the operation can include increasing the motion detection sampling rate to about every 0.25 seconds. Accordingly, the operation 210 can ensure that the unacceptable tire pressure is determined as quickly as possible after the vehicle begins moving, e.g., even using conventional logic.

At an operation 212, the process 200 includes detecting motion. For instance, conventional TMP systems have associated logic for detecting motion, e.g., using IMUs, or the like. During motion, the tire pressure sampling rate is increased, e.g., relative to when the vehicle is stationary or off, to indicate tire pressure problems relatively quickly during operation of the vehicle. However, in some conventional systems, detecting motion is done at a relatively low frequency, e.g., once every 15 seconds or more. The operation 210 may increase this rate to under a second, resulting in a sooner response, with motion being detected at the operation 212 much more quickly than in conventional systems.

At an operation 214, the process 200 includes generating and transmitting an alert. In examples, the alert can be generated by the vehicle computing system in response to the wake signal being received, e.g., in accordance with the operation 208. In such an example, the warning can be presented to the user upon entering the vehicle, starting the vehicle, or the like. In other examples, the alert can be transmitted to an electronic device associated with the driver, owner of the vehicle, or the like. In this example, the vehicle owner can investigate the tire pressure anomaly at their convenience, e.g., instead of upon entering the vehicle to travel somewhere. In instances in which the wake signal is not received, the alert will be generated and transmitted in accordance with a motion detection at the operation 212, in response to the higher motion sampling rate of the operation 210. While this may require the driver to be in the vehicle, the techniques described herein can alert the driver/passenger to the potentially hazardous tire pressure within about a quarter of a tire revolution, or quicker.

Alternatively, if at the operation 208 it is determined that the sampled pressure is an acceptable pressure, processing returns to the operation 206 to continue to sample at the modified sample rate.

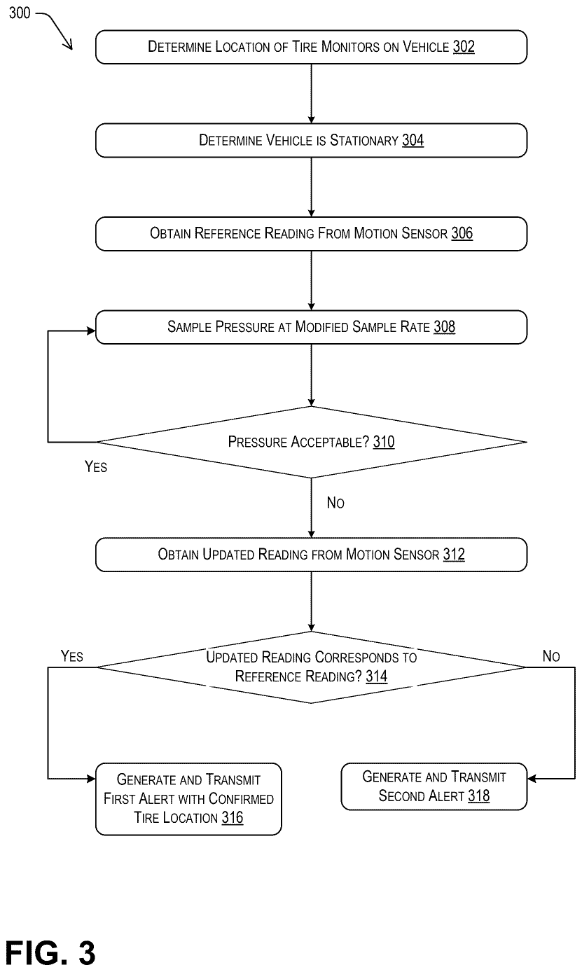

FIG. 3 shows another example process 300 for alerting a person associated with a vehicle to a tire pressure anomaly. Aspects of the process 300 can be undertaken by aspects of the tire monitor 104, the vehicle computing system(s) 116, and/or the like. However, the process 300 is not limited to be performed by these systems/components, and the systems/components are not limited to performing the operations of the process 300.

At an operation 302, the process 300 includes determining a location of tire monitors on a vehicle 302. For example, the operation 302 can include performing an auto-location procedure on the tire monitors associated with a vehicle while the vehicle 100. The auto-location procedure may require that the vehicle be moving, e.g., to determine a direction of rotation of a tire, forces on the tire(s) during operation of the vehicle, and/or the like. In examples, the operation 302 can include determining and storing an association of a tire monitor with a location on the vehicle. Without limitation, the location may correspond to a front or rear of the vehicle and/or to a passenger or driver side of the vehicle.

At an operation 304, the process 300 includes determining that a vehicle is stationary. For example, the operation 304 may be the same as the operation 202, discussed above. In examples, the tire monitor 104 can include the motion sensing component 108 for generating readings. The tire monitor 104 and/or the vehicle computing system(s) 116 can include functionality to determine that the vehicle is stationary based at least in part on information from the motion sensing component 108.

At an operation 306, the process 300 includes obtaining a reference reading from the motion sensor. For example, the motion sensor can detect a current rotational position, orientation, and/or other attribute of the tire and/or of the tire monitor. In examples, the reference reading may also include an association of the tire with a position on the vehicle, e.g., driver-side right, rear passenger, or the like. The operation 306 is performed at least in part in response to determining that the vehicle is stationary, at the operation 304. In examples, the operation 306 may determine a status of the tires/tire monitors upon the vehicle becoming stationary.

At an operation 308, the process 300 includes sampling pressure at a modified sample rate. For example, the operation 308 can be similar to or the same as the operation 204 discussed above. Without limitation, the pressure may be sampled at a non-zero sampling rate while the vehicle is stationary.

At an operation 310, the process 300 includes determining whether a pressure is acceptable. For example, the operation 310 may be similar to or the same as the operation 206 discussed above. Without limitation, tire pressure measurements taken at the modified sampling rate may be compared to one or more pressure thresholds associated with operating parameters for the tire(s).

At an operation 312, the process 300 includes obtaining an updated reading from the motion sensor. For example, at least in part in response to determining that a tire pressure measurement is unacceptable, the process 300 can determine whether a tire or a tire monitor has moved. For example, the operation 312 may include causing the motion sensing component 108 to determine a current rotational position, orientation, or other attribute of the tire. The updated reading may include the same type of data as the reference reading determined at the operation 306, discussed above.

At an operation 314, the process 300 determines whether the updated reading corresponds to the reference reading. For example, where the reference reading and the updated reading are rotational positions, angles, or the like, the operation 312 can include comparing such positions, angles, or the like. In examples, the reference reading and the updated reading may correspond if they are the same and/or if they are within a threshold of each other, e.g., 1%, 5%, or the like.

If, at the operation 314, it is determined that the updated reading corresponds to the reference reading, at an operation 316, the process 300 includes generating and transmitting a first alert with the confirmed tire location. For example, the first alert may indicate to someone associated with the vehicle that an unacceptable pressure condition has been identified. The first alert may also indicate the location of the tire, e.g., based on the location determined at the operation 302. More specifically, because at the operation 314 the process 300 has determined that the updated reading corresponds to the reference reading, the location determined at the operation 302 can be confirmed, e.g., the location has not changed during the time in which the vehicle has been stationary.

Alternatively, if, at the operation 314 it is determined that the updated reading does not correspond to the reference reading, at an operation 318, the process 300 includes generating and transmitting a second alert. For example, the second alert, like the first alert, can warn of an anomalous tire pressure, but the second alert may not include an indication of a location of the tire. Alternatively, the second alert can include an explicit indication that the tire with the anomalous reading may have been moved, an indication of the location of the tire determined at the operation 302, and/or any other information. For instance, the first alert and/or the second alert can alert a car owner on a computing device, such as a smart phone or the like, that safe operation of the vehicle cannot be guaranteed. In other examples, the alert can be transmitted to the vehicle, e.g., for presentation on a vehicle display, for viewing by a driver upon getting into the vehicle.

In examples of this disclosure, an operator can be informed of a critical pressure issue as well as of a location of the tire having the issue, while the vehicle is stationary. The operator can thus inspect and/or fix, e.g., by inflating or replacing the tire. Because the location check, e.g., based on the updated reading obtained at the operation 312 is performed in response to determining a pressure anomaly or critical pressure issue, false positives, e.g., resulting from wheel rotation during service, wheel replacement, or the like, may be reduced.

Aspects of this disclosure may also reduce or eliminate the need for auto-location cycles in a tire pressure monitoring system. Such cycles are generally carried out at the start of every drive and have a large impact on the battery. For instance, although the process 300 contemplates obtaining the updated reading from the motion sensor (at the operation 312) in response to detection of a tire anomaly, in other examples the updated reading can be received at start-up of the vehicle or in response to some other input. Specifically, determining if the updated reading corresponds to the reference reading will allow the system to know with a high probability that the wheel(s) has/have not moved. In contrast, if the readings do not correspond, the system knows with high certainty that the wheels have been moved since the last auto-location cycle and can generate a warning. Thus, aspects of the process 300 can be used to validate tire locations, regardless of the reason for the validation.

As apparent from the foregoing, aspects of this disclosure provide improved detection of unsafe driving conditions associated with tire pressure anomalies. For example, aspects of this disclosure can alert a vehicle owner, driver, passenger, or other person associated with a vehicle of tire pressure anomalies arising when the vehicle is stationary, before the vehicle moves and/or as soon as possible after initial movement. Previous tire pressure monitoring systems often required lengthy processes that only detect tire pressure anomalies after continued and sustained motion.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A tire pressure monitoring system comprising:
a pressure sensing component associated with a tire of a vehicle;
a motion sensing component associated with the tire of the vehicle;
a transmitter; and
a controller, the controller being configured to perform actions comprising:
determining, based at least in part on motion data from the motion sensing component, that the vehicle is stationary;
adjusting, based at least in part on the vehicle being stationary, a pressure sampling rate associated with the pressure sensing component to a non-zero sampling rate;
receiving, at the non-zero sampling rate, pressure data from the pressure sensing component;
determining that the pressure data corresponds to an unacceptable tire pressure; and
sending, via the transmitter, data associated with the unacceptable tire pressure.

2. The tire pressure monitoring system of claim 1, the actions further comprising:
adjusting a motion sampling rate associated with the motion sensing component based at least in part on the first pressure data corresponding to the unacceptable tire pressure.

3. The tire pressure monitoring system of claim 2, wherein the adjusting the motion sampling rate comprises increasing the motion sampling rate to an increased motion sampling rate, the actions further comprising:
sampling the motion sensing component at the increased motion sampling rate;
determining, based on the sampling, motion of the vehicle; and
transmitting the data associated with the unacceptable tire pressure upon determining the motion of the vehicle.

4. The tire pressure monitoring system of claim 3, wherein the increased motion sampling rate is equal to or less than one second per sample.

5. The tire pressure monitoring system of claim 1, wherein the determining that the pressure data corresponds to an unacceptable tire pressure comprises comparing the pressure data to a threshold tire pressure.

6. The tire pressure monitoring system of claim 1, wherein the data associated with the unacceptable tire pressure comprises a wake signal to wake a vehicle computing system.

7. The tire pressure monitoring system of claim 6, wherein the vehicle computing system is configured to at least one of:
cause the vehicle to provide a visual display associated with the unacceptable tire pressure on a display device of the vehicle; or
transmit the data associated with the unacceptable tire pressure to a remote computing device associated with a person associated with the vehicle.

8. The tire pressure monitoring system of claim 1, the actions further comprising:
determining a location of the tire on the vehicle;
generating, based at least in part on determining that the vehicle is stationary and using the motion sensing component, a reference motion reading associated with the tire; and
generating, based at least in part on the determining that the pressure data corresponds to the unacceptable tire pressure, an updated motion reading associated with the tire.

9. The tire pressure monitoring system of claim 8, the actions further comprising:
confirming, based at least in part on the updated motion reading corresponding to the reference motion reading, the location of the tire on the vehicle,
wherein the data further identifies the location of the tire on the vehicle.

10. The tire pressure monitoring system of claim 9, wherein the tire is a first tire, the actions further comprising:
receiving supplemental wheel location data associated with a second tire; and
verifying, based at least in part on the supplemental wheel location data, the location of the tire on the vehicle.

11. The tire pressure monitoring system of claim 8, the actions further comprising:
determining, based at least in part on the updated motion reading not corresponding to the reference motion reading, that the location of the tire on the vehicle is unknown.

12. A method comprising:
determining, based at least in part on motion data from a motion sensor associated with a tire on a vehicle, that the vehicle is stationary;
in response to determining that the vehicle is stationary, setting a non-zero pressure sampling rate of a pressure sensor associated with the tire;
determining, at the non-zero pressure sampling rate, a series of pressure measurements for the tire;
determining that a pressure measurement of the series of pressure measurements corresponds to an unacceptable tire pressure; and
transmitting an alert associated with the unacceptable tire pressure.

13. The method of claim 12, further comprising:
adjusting, based at least in part on the pressure measurement corresponding to the unacceptable tire pressure, an increased sampling rate associated with the motion sensor.

14. The method of claim 13, further comprising:
determining, based at least in part on second motion data associated with the increased sampling rate, that the tire is moving; and
causing, based at least in part on the tire moving, a display to an operator of the vehicle indicative of the alert.

15. The method of claim 12, further comprising:
determining, prior to determining that the vehicle is stationary, a location of the tire on the vehicle;
determining, based at least in part on determining that the vehicle is stationary, a reference motion reading for the tire; and
determining, based at least in part on determining that the pressure measurement corresponds to an unacceptable tire pressure, an updated motion reading for the tire.

16. The method of claim 15, further comprising:
comparing the updated motion reading to the reference motion reading, wherein the alert comprises one of:
an indication of the location of the tire on the vehicle, in response to the comparing indicating that the updated motion reading corresponds to the reference motion reading; or
an indication that a position of the tire on the vehicle is unknown, in response to the comparing indicating that the updated motion reading does not correspond to the reference motion reading.

17. A vehicle comprising:
a plurality of tires; and
a tire pressure monitoring system comprising:
a pressure sensor associated with one of the plurality of tires;
a motion sensor configured to determine motion of the vehicle; and
a controller configured to perform actions comprising:
determining a first location of a first tire of the plurality of tires on the vehicle;
determining, based at least in part on motion data from the motion sensor, that the vehicle is stationary;
determining, using the motion sensor and based at least in part on determining that the vehicle is stationary, a reference motion reading associated with a first tire of the plurality of tires;
determining, with the vehicle stationary and based at least in part on pressure data from the pressure sensor, that a tire pressure of the first tire is unacceptable;
determining, based at least in part in response to determining that the tire pressure of the first tire is unacceptable, an updated motion reading associated with the first tire; and
determining, based on the updated motion reading associated with the first tire corresponding to the reference motion reading, that the first tire is at the first location.

18. The vehicle of claim 17, the actions further comprising:
generating an alert indicating that the first tire, at the first location on the vehicle, has an unacceptable pressure; and
causing the alert to be at least one of:
displayed on a display of the vehicle; or
transmitted to a computer device associated with a person associated with the vehicle.

19. The vehicle of claim 17, the actions further comprising:
transmitting a wake-up signal to a computing system associated with the vehicle.

20. The vehicle of claim 17, the actions further comprising:
at least in part in response to determining that a tire pressure of the first tire is unacceptable, increasing a sampling rate of the motion sensor.
